(19) United States
(12) Patent Application Publication
(10) Pub. No.: US 2021/0054572 A1
(43) Pub. Date: Feb. 25, 2021

(54) LAYERED FIBROUS STRUCTURES COMPRISING CROSS-LINKED FIBERS

(71) Applicant: Kimberly-Clark Worldwide, Inc., Neenah, WI (US)

(72) Inventors: Michael Andrew Zawadzki, Appleton, WI (US); Stephen Michael Lindsay, Appleton, WI (US); Thomas Gerard Shannon, Neenah, WI (US)

(21) Appl. No.: 16/982,867

(22) PCT Filed: Mar. 29, 2018
(86) PCT No.: PCT/US18/25007

§ 371 Date: Sep. 21, 2020

(51) Int. Cl. D21H 27/38; D21H 27/00; D21H 11/20; D21F 11/04; D21G 1/00; B32B 5/02; B32B 5/26; B32B 29/00

(52) U.S. Cl. CPC D21H 27/38; D21H 27/005; D21H 11/20; B32B 29/005; D21G 1/00; B32B 5/022; B32B 5/26; D21F 11/04

(57) ABSTRACT

The invention provides fibrous structures, such as tissue products, manufactured using non-compressive dewatering and drying methods, such as through-air drying, where the structures are multi-layered and have cross-linked fibers selectively disposed in one or more outer most layers. Compared to similarly prepared fibrous structures that are substantially free from cross-linked fibers the instant fibrous structures have improved surface properties, such as good softness and smoothness, as well as improved bulk. Further, by layering the cross-linked fibers and manufacturing the fibrous structures without compressive dewatering the tensile strength of the finished structure is not degraded.

### BACKGROUND OF THE DISCLOSURE

Today there is an ever increasing demand for soft, bulky tissue products, which also have sufficient tensile strength to withstand use. Traditionally the tissue maker has solved the problem of increasing sheet bulk without compromising strength and softness by adopting tissue making processes that only minimally compress the tissue web during manufacture, such as through-air drying. Although such techniques have improved sheet bulk, they have their limitations. For example, to obtain satisfactory softness the through-air dried tissue webs often need to be calendered, which may negate much of the bulk obtained by through-air drying.

Tissue product bulk may also be increased by treating a portion of the papermaking furnish with chemicals that facilitate the formation of covalent bonds between adjacent cellulose molecules. This process, commonly referred to as cross-linking, often involves the reaction of water soluble multi-functional molecules capable of reacting with cellulose under mildly acidic conditions. The cross-linking agents are generally methylol or alkoxymethyl derivatives of different N-containing compounds such as urea and cyclic ureas. Polycarboxylic acids and citric acid have also been used with varying degrees of success. Sheets formed from cross-linked cellulosic fibers, while having increased bulk, generally have poor tensile and tear strength, because of reduced fiber to fiber bonding.

To lessen the negative effects of cross-linked fibers the prior art has resorted to alternative cross-linking agents and to blending cross-linked and uncross-linked fibers together. For example, in U.S. Pat. No. 3,434,918 sheeted fiber is treated with a crosslinking agent and catalyst and wet aged to insolubilize the crosslinking agent. The fiber sheet is then dispersed and blended with non-cross-linked fibers to form a fiber slurry used to form a creped tissue web, which is subsequently passed under a dryer to cure the crosslinking-agent. In U.S. Pat. No. 3,455,778 bleached southern softwood kraft pulp is reacted with dimethylol urea to form cross-linked fibers, which are blended with untreated hardwood and softwood pulps. The blended pulps were used to form a creped tissue web having improved absorbent properties. In U.S. Pat. No. 4,204,054 wood pulp fibers were sprayed with a solution of formaldehyde, formic acid and hydrochloric acid and then immediately dispersed in a hot air stream for 1-20 seconds to form cross-linked fibers. The cross-linked fibers were then blended with uncross-linked fibers to form a sheet having improved flexibility and water absorbency. Finally, in U.S. Pat. No. 6,837,972 cross-linked cellulosic fibers are blended with softwood kraft pulps having an elevated hemicellulose content to form tissue webs. The tissue webs, while having increased bulk, have greatly diminished tensile strength.

Accordingly, what is needed in the art is a tissue product comprising cross-linked fibers that is both bulky and strong without any decrease in softness.

### SUMMARY OF THE DISCLOSURE

It has now been surprisingly discovered that the surface smoothness and softness of non-compressively dewatered fibrous structures, such as tissue webs and products, may be improved by forming the structures from a fiber furnish comprising cross-linked cellulosic fibers and more specifically cross-linked hardwood fibers such as cross-linked eucalyptus kraft fibers. The surface smoothness and softness of the inventive fibrous structures is particularly improved when the structures comprise three or more layers and the two outermost layers comprise cross-linked cellulosic fibers. Surprisingly, the addition of cross-linked fibers to the outer most layers of the fibrous structure do not overly stiffen the sheet, negatively affect tensile strength or cause increased slough.

Even more surprisingly, by selectively incorporating cross-linked cellulosic fibers and more specifically cross-linked hardwood kraft fibers into the outermost layers of a multilayered fibrous structure the present inventors were able to effectively shift the strength/softness curve. That is, the inventive fibrous structures have a lower TS7 value, an objective measure of structure softness, at a given tensile strength compared to comparable structures prepared without cross-linked cellulosic fibers. Not only are the inventive structures softer at a given tensile strength, their surface smoothness is improved as a result of selectively incorporating cross-linked cellulosic fibers. For example, inventive fibrous structures having a geometric mean tensile strength (GMT) from about 500 to about 1,250 g/3″ generally have a TS750 value, an objective measurement of surface smoothness, less than about 60.

Accordingly, in one embodiment the present invention provides a non-compressively dewatered fibrous structure comprising first and second fibrous outer layers and a middle fibrous layer disposed there-between the outer layers comprising from about 5 to about 30 percent, by weight of the layer, cross-linked hardwood fibers, and the middle layer substantially free from cross-linked hardwood fibers, the fibrous structure having good softness, such as a TS7 value less than about 12 and a relatively smooth surface, such as a TS750 value less than about 60.

In other preferred embodiments the invention provides a single ply non-compressively dewatered tissue product having a basis weight from about 30 to about 45 grams per square meter (gsm), a GMT greater than about 500 g/3″, and Stiffness Index less than about 10, such as from about 6.0 to about 10 and more preferably from about 6.0 to about 8.5, the tissue product comprising first and second fibrous outer layers and a middle fibrous layer disposed there-between, the outer layers comprising cross-linked hardwood fibers and the middle layer substantially free from cross-linked hardwood fibers.

In yet other embodiments, the invention provides a tissue product comprising a single ply uncreped, through-air dried tissue web comprising first and second fibrous outer layers and a middle fibrous layer disposed there-between wherein cross-linked hardwood fibers are selectively disposed in the outer layers and the product comprises from about 5 to about 30 percent, by weigh to the product, cross-linked hardwood fibers. The foregoing tissue products may have a basis weight from about 30 to about 45 gsm, a GMT greater than about 500 g/3″, such as from about 500 to about 1,250 g/3″ a Stiffness Index less than about 10, such as from about 6.0 to about 10 and a TS7 value less than about 12, such as from about 8.0 to about 12.

In other embodiments the present invention provides a two-ply tissue product comprising a first through-air dried multi-layered tissue web and a second through-air dried multi-layered tissue web that are plied together using well-known techniques. The through-air dried multi-layered webs comprise at least a first and a second layer, wherein cross-linked fibers are selectively incorporated into a layer brought into contact with a user's skin during use and the other layer is substantially free of cross-linked fibers. The foregoing two-ply tissue product comprises from about 5 to about 30 percent, and more preferably from about 10 to about 25 percent, by weight of the product, cross-linked fiber, wherein the product has a basis weight from about 20 to about 50 gsm, a GMT from about 500 to about 1,250 g/3″, a sheet bulk greater than about 12 cc/g and a TS7 value less than about 12. The multi-ply tissue product may have a relatively smooth outer surface as a result of the outer layer of the constituent webs comprising cross-linked fibers. For example, the outer surface may have a TS750 value less than about 60 and more preferably less than about 55, such as from about 30 to about 60 and more preferably from about 30 to about 55 and still more preferably from about 30 to about 50.

In still other embodiments the present provides a tissue product comprising at least one multi-layered tissue web where cross-linked fibers are selectively incorporated in the outer layers thereof, the tissue product having increased bulk relative to a substantially identical tissue product that is substantially free from cross-linked fibers. The increase in bulk may be at least about 5 percent, and more preferably at least about 10 percent, and still more preferably at least about 15 percent, such as from about 5 to about 20 percent. For example, the inventive tissue products may have a bulk from 14.0 to about 20.0 cc/g, a basis weight from about 20 to about 50 gsm, a GMT from about 500 to about 1,250 g/3″ and a TS7 value less than about 12.

### BRIEF DESCRIPTION OF DRAWINGS

FIG. 1 is a plot of TS7, having units of dB V² rms (y-axis) versus GMT, having units of g/3″ (x-axis), for control (▴) and inventive (●) samples;

FIG. 2 is a plot of TS750, having units of dB V² rms (y-axis) versus GMT, having units of g/3″ (x-axis), for control (▴) and inventive (●) samples; and

FIG. 3 is a plot of Geometric Mean Modulus (GMM), having units of grams (y-axis) versus GMT, having units of g/3″ (x-axis), for control (▴) and inventive (●) samples.

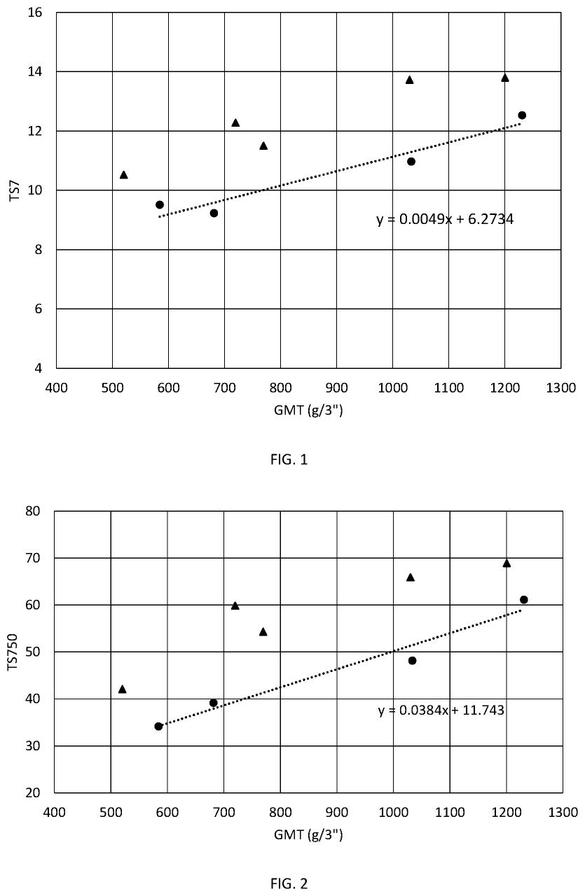

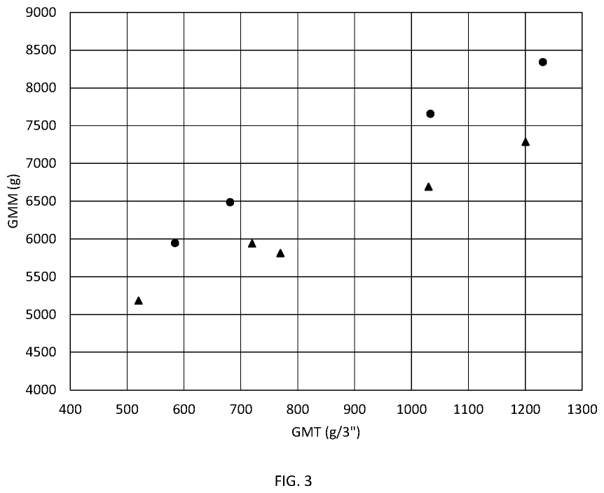

### DEFINITIONS

As used herein the terms “cross-linked fiber” and “cross-linked cellulosic fiber” generally refer to any cellulosic fibrous material reacted with a cross-linking agent.

As used herein the term “fibrous structure” generally refers to a structure, such as a sheet, that comprises a plurality of fibers. In one example, a fibrous structure according to the present invention means an orderly arrangement of fibers within a structure in order to perform a function. Nonlimiting examples of fibrous structures of the present invention include paper, fabrics (including woven, knitted, and non-woven), and absorbent pads (for example for diapers or feminine hygiene products). Nonlimiting examples of processes for making fibrous structures include known wet-laid papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fiber slurry is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a tissue product.

As used herein, the term “tissue product” refers to products made from tissue webs and includes, bath tissues, facial tissues, paper towels, industrial wipers, foodservice wipers, napkins, medical pads, and other similar products. Tissue products may comprise one, two, three or more plies.

As used herein, the terms “tissue web” and “tissue sheet” refer to a fibrous structure in the form of a sheet suitable for forming a tissue product.

As used herein, the term “layer” refers to a plurality of strata of fibers, chemical treatments, or the like, within a ply.

As used herein, the terms “layered tissue web,” “multi-layered tissue web,” “multi-layered web,” and “multi-layered fibrous structure,” generally refer to a fibrous structure in the form of a sheet prepared from two or more layers of aqueous papermaking furnish which are preferably comprised of different fiber types. The layers are preferably formed from the deposition of separate streams of dilute fiber slurries, upon one or more endless foraminous screens. If the individual layers are initially formed on separate foraminous screens, the layers are subsequently combined (while wet) to form a layered composite web. In certain preferred embodiments the invention provides multi-layered fibrous structures consisting of three layers where the two outermost layers comprise a first fiber furnish and the middle layer comprises a second, different, fiber furnish.

As used herein the term “ply” refers to a discrete product element. Individual plies may be arranged in juxtaposition to each other. The term may refer to a plurality of web-like components such as in a multi-ply facial tissue, bath tissue, paper towel, wipe, or napkin.

As used herein, the term “basis weight” generally refers to the bone dry weight per unit area of a tissue and is generally expressed as grams per square meter (gsm). Basis weight is measured using TAPPI test method T-220.

As used herein, the term “geometric mean tensile” (GMT) refers to the square root of the product of the machine direction tensile and the cross-machine direction tensile of the web, which are determined as described in the Test Method section.

As used herein, the term “caliper” is the representative thickness of a single sheet (caliper of tissue products comprising two or more plies is the thickness of a single sheet of tissue product comprising all plies) measured in accordance with TAPPI test method T402 using a ProGage 500 Thickness Tester (Thwing-Albert Instrument Company, West Berlin, N.J.). The micrometer has an anvil diameter of 2.22 inches (56.4 mm) and an anvil pressure of 132 grams per square inch (per 6.45 square centimeters) (2.0 kPa).

As used herein, the term “sheet bulk” refers to the quotient of the caliper (μm) divided by the bone dry basis weight (gsm). The resulting sheet bulk is expressed in cubic centimeters per gram (cc/g).

As used herein, the term “slope” refers to slope of the line resulting from plotting tensile versus stretch and is an output of the MTS TestWorks™ in the course of determining the tensile strength as described in the Test Methods section herein. Slope is reported in the units of grams (g) per unit of sample width (inches) and is measured as the gradient of the least-squares line fitted to the load-corrected strain points falling between a specimen-generated force of 70 to 157 grams (0.687 to 1.540 N) divided by the specimen width. Slopes are generally reported herein as having units of grams per 3 inch sample width or g/3″.

As used herein, the term “geometric mean slope” (GM Slope) and “geometric mean modulus” (GMM) generally refers to the square root of the product of machine direction slope and cross-machine direction slope. GM Slope may have units of kilograms or grams.

As used herein, the term “Stiffness Index” refers to the quotient of the geometric mean slope (having units of g/3″) divided by the geometric mean tensile strength (having units of g/3″).

As used herein the term “substantially free” refers to a layer of a tissue that has not been formed with the addition of cross-linked fiber. Nonetheless, a layer that is substantially free of cross-linked fiber may include de minimus amounts of cross-linked fiber that arise from the inclusion of cross-linked fibers in adjacent layers and do not substantially affect the softness or other physical characteristics of the tissue web.

As used herein, the term “through-air dried” generally refers to a method of manufacturing a tissue web where a drying medium, such as heated air, is blown through a perforated cylinder, the embryonic tissue web and the fabric supporting the web. Generally the embryonic tissue web is supported by the fabric and is not brought into contact with the perforated cylinder.

As used herein, “noncompressive dewatering” and “noncompressive drying” refer to dewatering or drying methods, respectively, for removing water from tissue webs that do not involve compressive nips or other steps causing significant densification or compression of a portion of the web during the drying or dewatering process. In particularly preferred embodiments the wet web is wet-molded in the process of noncompressive dewatering to improve the softness and smoothness of the web with minimal degradation of tensile strength.

As used herein, the terms “T57” and “TS7 value” refer to an output of an EMTEC Tissue Softness Analyzer (“TSA”) (Emtec Electronic GmbH, Leipzig, Germany) as described in the Test Methods section. The units of the TS7 are dB V² rms, however, TS7 values are often referred to herein without reference to units.

As used herein, the terms “TS750” and “TS750 value” refer to the output of the EMTEC Tissue Softness Analyzer as described in the Test Methods section. TS750 has units of dB V² rms, however, TS750 may be referred to herein without reference to units.

### DETAILED DESCRIPTION OF THE DISCLOSURE

The present invention provides fibrous structures manufactured by non-compressive dewatering and drying methods, such as through-air drying, where the structures are multi-layered and have cross-linked fibers selectively disposed in one or more outer most layers. For example, the inventive fibrous structures may be multi-layered tissue webs, and tissue products comprising the same, having cross-linked hardwood fibers selectively disposed in the skin-contacting layer of the multi-layered tissue web. By selectively incorporating cross-linked fibers, and more specifically cross-linked hardwood fibers, into the outermost layers of a multilayered fibrous structure the present inventors were able to effectively shift the strength/softness curve. As such, the present invention provides a non-compressively dewatered fibrous structure comprising first and second fibrous outer layers and a middle fibrous layer disposed there-between, wherein the structure comprises from about 5 to about 30 percent, by weight of the structure, cross-linked hardwood fibers, and the middle layer is substantially free from cross-linked hardwood fibers, the fibrous structure having good softness, such as a TS7 value less than about 12, such as from about 6.0 to about 12, and a relatively smooth surface, such as a TS750 value less than about 60 and more preferably less than about 55 and still more preferably less than about 50, such as from about 30 to about 60 and more preferably from about 30 to about 55 and still more preferably from about 30 to about 50.

In a preferred embodiment the fibrous structures are multi-layered and through-air dried and comprise at least about 5 percent, by weight of the fibrous structure cross-linked fiber, and more preferably at least about 10 percent and still more preferably at least about 15 percent. For example, the fibrous structures may comprise from about 5 to about 30 percent, by weight of the structure cross-linked fibers and in other embodiments from about 10 to about 25 percent cross-linked fibers. The cross-linked fibers may be selectively disposed in only one of the layers such that the cross-linked fibers are not brought into contact with the user's skin in-use. For example, the fibrous structure may comprise a two layered web wherein the first layer consists essentially of conventional wood pulp fibers and is substantially free from cross-linked fibers and the second layer comprises a blend of conventional wood pulp fibers and cross-linked hardwood kraft fibers, wherein the cross-linked fibers comprise from about 5 to about 25 percent of the weight the fibrous structure. It should be understood that, when referring to a layer that is substantially free of cross-linked fibers, negligible amounts of the fibers may be present therein, however, such small amounts often arise from the cross-linked fibers applied to an adjacent layer, and do not typically substantially affect the softness or other physical characteristics of the web.

The fibrous structures may be incorporated into tissue products that may be either single or multi-ply, where one or more of the plies may be formed by a multi-layered tissue web having cross-linked fibers selectively incorporated in one of its layers. In a particularly preferred embodiment, tissue product is constructed such that the cross-linked fibers are not brought into contact with the user's skin in-use. For example, the tissue product may comprise two multi-layered through-air dried webs wherein each web comprises a first fibrous layer substantially free from cross-linked fiber and a second fibrous layer comprising cross-linked fiber. The webs are plied together such that the outer surface of the tissue product is formed from the first fibrous layers of each web, such that the surface brought into contact with the user's skin in-use is substantially free of cross-linked fibers.

The fibrous structures have improved sheet properties, such as improved softness, smoothness and bulk, compared to substantially similar structures prepared without cross-linked fibers. For example, the non-compressive dewatered fibrous structures prepared according to the present invention may be converted into tissue products having sheet bulk greater than about 12.0 cc/g and more preferably greater than about 14.0 cc/g and still more preferably greater than about 15.0 cc/g, such as from about 12.0 to about 18.0 cc/g and more preferably from about 14.0 to about 16.0 cc/g. The foregoing tissue webs can be converted to tissue products without a significant loss of sheet bulk, while preserving a relatively high degree of tensile strength.

Surprisingly, the increase in bulk is achieved without a corresponding decrease in strength and without significant stiffening of the fibrous structure. For example, tissue products prepared according to the present invention may have a geometric mean tensile strength (GMT) greater than about 500 g/3″, more preferably greater than about 600 g/3″ and still more preferably greater than about 800 g/3″, such as from about 500 to about 1,500 g/3″ and more preferably from about 600 to about 1,200 g/3″. At the foregoing tensile strengths the fibrous structures generally have a Stiffness Index less than about 12.0 and more preferably less than about 10.0 and still more preferably less than about 8.0 such as from about 6.0 to about 12.0 and more preferably from about 6.0 to about 10.0.

In addition to having improved bulk, good tensile strength and low stiffness, the instant webs and products also display favorable softness and smoothness. Softness and smoothness are objectively measured herein using a Tissue Softness Analyzer, as described below, and reported as TS7 (softness) and TS750 (surface smoothness). For example, the fibrous structures may have a TS7 less than about 12.0, more preferably less than about 11.0 and still more preferably less than about 10.0, such as from about 8.0 to about 12.0. In other instances the fibrous structures may have a reduced TS7 at a given tensile strength compared to comparable structures that are substantially free from cross-linked fibers. For example, the fibrous structures have a TS7 that is a function of tensile strength (measured as GMT having units of g/3″) and expressed by the equation:

TS7=0.0049*GMT+6.2734

Where GMT ranges from about 500 to about 1,250 g/3″.

In other embodiments the fibrous structures may have a reduced TS750 at a given tensile strength compared to comparable structures that are substantially free from cross-linked fibers. For example, the fibrous structures have a TS750 that is a function of tensile strength (measured as GMT having units of g/3″) and expressed by the equation:

TS750=0.0384*GMT+11.743

Where GMT ranges from about 500 to about 1,250 g/3″.

To form the inventive fibrous structures cross-linked fibers, such as cross-linked cellulosic fibers, are selectively incorporated into one or more layers of a layered fibrous structure while the other layers comprise non-cross linked fibers and are substantially free from cross-linked cellulosic fibers. The non-cross linked fibers may generally comprise any conventional papermaking fiber, which are well known in the art. For example, non-cross-linked fibers may comprise wood pulp fibers formed by a variety of pulping processes, such as kraft pulp, sulfite pulp, thermomechanical pulp, etc. Further, the wood pulp fibers may comprise high-average fiber length wood pulp fibers or low-average fiber length wood pulp fibers, as well as mixtures of the same. One example of suitable high-average length wood pulp fibers include softwood fibers such as, but not limited to, northern softwood, southern softwood, redwood, red cedar, hemlock, pine (e.g., southern pines), spruce (e.g., black spruce), combinations thereof, and the like. One example of suitable low-average length wood pulp fibers include hardwood fibers, such as, but not limited to, eucalyptus, maple, birch, aspen, and the like, which can also be used. Moreover, if desired, secondary fibers obtained from recycled materials may be used, such as fiber pulp from sources such as, for example, newsprint, reclaimed paperboard, and office waste.

The non-cross-linked fibers are generally incorporated into the multi-layered fibrous structures such that at least one of the layers is substantially free from cross-linked fibers and consists essentially of non-cross-linked fibers. In one embodiment the fibers are arranged in layers such that the fibrous structure has a first layer comprising a blend of cross-linked hardwood kraft fibers and non-cross-linked fibers and a second layer consisting essentially of softwood kraft pulp fiber, where the second layer is substantially free of cross-linked fibers. In such embodiments the cross-linked fiber may be added to the first layer, such that the fibrous structure comprises from about 5 to about 25 percent cross-linked fibers, by weight of the fibrous structure.

In other embodiments the invention provides a multi-layered tissue web comprising cross-linked fibers selectively disposed in one or more layers, wherein the tissue layer comprising cross-linked fibers is adjacent to a layer comprising non cross-linked fiber and which is substantially free from non-cross-linked fiber. In a particularly preferred embodiment the cross-linked cellulosic fibers are selectively incorporated into at least one outer layer of a three layered fibrous structure and more preferably the two outer most layers of the three layer structure. For example, the cross-linked cellulosic fibers may comprise cross-linked-eucalyptus hardwood kraft pulp fibers (XL-EHWK) which may be selectively incorporated in both outer most layers of a three-layered structure and the middle layer may consist essentially of non-cross-linked cellulosic fibers, such as non-cross-linked Northern softwood kraft fiber (NSWK).

While the foregoing structures represent certain preferred embodiments it should be understood that the tissue product can include any number of plies or layers and can be made from various types of conventional unreacted cellulosic fibers and cross-linked fibers. For example, the tissue webs may be incorporated into tissue products that may be either single or multi-ply, where one or more of the plies may be formed by a multi-layered tissue web having cross-linked fibers selectively incorporated in one of its layers.

The cross-linked fibers useful in preparing the through-air dried fibrous structures of the present invention may be prepared using a wide variety of cross-linking agents, which are well known in the art. For example, U.S. Pat. No. 5,399,240, the contents of which are incorporated herein in a manner consistent with the present invention, discloses cross-linking agents, such as polycarboxylic acids, for cross-linking cellulosic fibers, which may be useful in the present invention.

In certain embodiments the cross-linking agent may comprise a urea-based cross-linking agent. Suitable urea-based cross-linking agents include substituted ureas such as methylolated ureas, methylolated cyclic ureas, methylolated lower alkyl cyclic ureas, methylolated dihydroxy cyclic ureas, dihydroxy cyclic ureas, and lower alkyl substituted cyclic ureas. Specific urea-based cross-linking agents include dimethyldihydroxy urea (DMDHU, 1,3-dimethyl-4,5-dihydroxy-2-imidazolidinone), dimethylol dihydroxy ethylene urea (DMDHEU, 1,3-dihydroxymethyl-4,5-dihydroxy-2-imidazolidinone), dimethylol urea (DMU, bis[N-hydroxymethyl]urea), dihydroxyethylene urea (DHEU, 4,5-dihydroxy-2 imidazolidinone), dimethylolethylene urea (DMEU, 1,3-dihydroxymethyl-2-imidazolidinone), and dimethyldihydroxyethylene urea (DMeDHEU or DDI, 4,5-dihydroxy-1,3-dimethyl-2-imidazolidinone). A particularly preferred urea is dimethyldihydroxy urea (DMDHU, 1,3-dimethyl-4,5-dihydroxy-2 imidazolidinone).

In certain embodiments the aqueous solution may further comprise a catalyst for increasing the rate of bond formation between the cross-linking agent and the cellulose fibers. Preferred catalysts include, for example, metal salts such as inorganic acids, including magnesium chloride, aluminum chloride and zinc chloride.

In other embodiments the cross-linking agent may comprise a glyoxal adduct of urea such as that disclosed in U.S. Pat. No. 4,968,774, the contents of which are incorporated herein in a manner consistent with the present disclosure.

In still other embodiments the cross-linking agent may comprise a dialdehyde. Suitable dialdehydes include, for example, C₂-C₈ dialdehydes, C₂-C₈ dialdehyde acid analogs having at least one aldehyde group, and oligomers of these aldehyde and dialdehyde acid analogs, such as those described in U.S. Pat. No. 8,475,631, the contents of which are incorporated herein in a manner consistent with the present disclosure. A particularly preferred dialdehyde glyoxal is ethanedial.

In still other embodiments the cross-linking agent may comprise polymeric polycarboxylic acids such as those disclosed in U.S. Pat. Nos. 5,221,285 and 5,998,511, the contents of which are incorporated herein in a manner consistent with the present disclosure. Suitable polymeric polycarboxylic acid cross-linking agents include, for example, polyacrylic acid polymers, polymaleic acid polymers, copolymers of acrylic acid, copolymers of maleic acid, and mixtures thereof. Specific suitable polycarboxylic acid cross-linking agents include citric acid, tartaric acid, malic acid, succinic acid, glutaric acid, citraconic acid, itaconic acid, tartrate monosuccinic acid, maleic acid, polyacrylic acid, polymethacrylic acid, polymaleic acid, polymethylvinylether-co-maleate copolymer, polymethylvinylether-co-itaconate copolymer, copolymers of acrylic acid, and copolymers of maleic acid.

In certain embodiments the aqueous solution may further comprise a catalyst for increasing the rate of bond formation between the cross-linking agent and the cellulose fibers. Preferred catalysts include alkali metal salts of phosphorous containing acids such as alkali metal hypophosphites, alkali metal phosphites, alkali metal polyphosphonates, alkali metal phosphates, and alkali metal sulfonates.

Suitable methods of preparing cross-linked fibers include those disclosed in U.S. Pat. No. 5,399,240, the contents of which are incorporated by reference in a manner consistent with the present disclosure. The cross-linking agent is applied to the cellulosic fibers in an amount sufficient to effect intrafiber cross-linking. The amount applied to the cellulosic fibers can be from about 1 to about 10 percent by weight based on the total weight of fibers. In one embodiment, the cross-linking agent is applied in an amount from about 4 to about 6 percent by weight based on the total weight of fibers.

In one embodiment cross-linked fibers may be prepared by first forming a mat of fiber, such as EHWK, and saturating the mat with an aqueous solution comprising a cross-linking agent selected from the group consisting of DMDHU, DMDHEU, DMU, DHEU, DMEU, and DMeDHEU. The pulp mat, after saturation with the solution, may be pressed to partially dry the mat and then further dried, such as by air drying, to produce a treated sheet. The treated sheet is then defibered in a hammer mill to form a fluff consisting essentially of individual fibers, which are then heated to between 300° F. and 340° F. to cure the fiber and effect cross-linking.

Generally the cross-linked fiber is not subject to further modification after formation. For example, the cross-linked fiber is generally not reacted with a chemical debonder to further inhibit hydrogen bonding between fibers. Chemical debonder agents are well known in the art and may comprise fatty chain quaternary ammonium salts. Similarly, the cross-linked fiber is generally not reacted with a wet strength agent to form covalent bonds between the cross-linked fibers and improve tensile strength properties when the resulting webs and products are wetted. Wet strength agents, both permanent and temporary, are well known in the art and may comprise water soluble, cationic oligomeric or polymeric resins. Examples of permanent wet strength agents include polyamine-epichlorohydrin, polyamide epichlorohydrin or polyamide-amine epichlorohydrin resins, collectively termed “RAE resins”. Examples of temporary wet strength agents include glyoxalated polyacrylamide resins, dialdehyde starch, polyethylene imine, mannogalactan gum, glyoxal, and dialdehyde mannogalactan.

While the cross-linked fibers are generally not subject to further modification after formation, other non-cross-linked fibers used in the formation of the inventive tissue products may be reacted with chemical debonders, cationic wet strength agents and the like. Thus, prior to formation of the wet tissue web, the non-cross-linked fiber may be reacted with a debonder, a permanent wet strength agent or a temporary wet strength agent. For example, a the non-cross-linked fiber may be dispersed in water to form an aqueous slurry of non-cross-linked fiber to which an effective amount of a debonder, a permanent wet strength agent or a temporary wet strength agent, or combinations thereof, may be added to yield a treated non-cross-linked fiber slurry. The treated non-cross-linked fiber slurry may then be disposed on a foraminous surface along with a cross-linked fiber slurry to form an embryonic web.

Compared to similar tissue products prepared without cross-linked fibers, tissue products prepared according to the present disclosure are generally softer and smoother at a given tensile strength and also have a higher sheet bulk. This effect is illustrated in the table below, which compares two similarly prepared single ply tissue products with 12 percent, by weight, cross-linked fiber and without cross-linked fibers.

TABLE 1

| | Sheet Bulk | GMT | Stiffness | | |
|---|---|---|---|---|---|
| Sample | (cc/g) | (g/3″) | Index | TS7 | TS750 |
| Control | 14.95 | 720 | 8.25 | 12.3 | 60 |
| Inventive | 15.47 | 681 | 9.53 | 9.2 | 39 |
| Delta | 3% | −6% | 13% | −34% | −54% |

Thus, in certain embodiments the present invention provides a non-compressively dewatered tissue product comprising from at least about 5 percent, such as from about 5 to about 30 percent, by weight of the weight of the tissue product, cross-linked fiber, wherein the product has a basis weight from about 20 to about 50 gsm, a GMT from about 500 to about 1250 g/3″, a sheet bulk greater than about 12.0 cc/g, such as from about 12.0 to about 16.0 cc/g, a TS7 less than about 12.0 and more preferably less than about 10.0, such as from about 8.0 to about 12.0, and a TS750 less than about 60, such as from about 30 to about 60 and more preferably from about 30 to about 50.

Fibrous structures of the present disclosure can generally be formed by a variety of papermaking processes using non-compressive dewatering and/or drying known in the art. Preferably the structures are formed by through-air drying and may be either creped or uncreped. For example, a papermaking process of the present disclosure can utilize adhesive creping, wet creping, double creping, embossing, wet-pressing, air pressing, through-air drying, creped through-air drying, uncreped through-air drying, as well as other steps in forming the paper web. Some examples of such techniques are disclosed in U.S. Pat. Nos. 5,048,589, 5,399,412, 5,129,988 and 5,494,554, all of which are incorporated herein in a manner consistent with the present disclosure. When forming multi-ply tissue products, the separate plies can be made from the same process or from different processes as desired.

The basis weight of tissue webs and products made in accordance with the present disclosure can vary depending upon the final product. For example, the process may be used to produce bath tissues, facial tissues, and the like. In general, the basis weight of the tissue web may vary from about 10 to about 50 gsm and more preferably from about 25 to about 45 gsm. Tissue webs may be converted into single and multi-ply bath or facial tissue products having basis weight from about 20 to about 50 gsm and more preferably from about 25 to about 45 gsm.

In certain embodiments fibrous structures produced according to the present invention may be subjected to additional processing after formation such as calendering in order to convert them into tissue products. The fibrous structures of the present invention are surprisingly resilient and retain a high degree of bulk compared to similar webs prepared without cross-linked fibers. The increased resiliency allows the webs to be calendered to produce a soft tissue product without a significant decrease in bulk, while providing the product with improved softness and surface smoothness.

Accordingly, in certain embodiments the present invention provides a tissue product having a basis weight from about 20 to about 50 gsm, and more preferably from about 25 to about 45 gsm, a GMT from about 500 to about 1250 g/3″, a sheet bulk from about 12.0 to about 16.0 g/3″, a TS7 from about 8.0 to about 12.0 and a TS750 less than about 60, such as from about 30 to about 60.

Further, in certain preferred embodiments, the improvement in z-direction properties does not come at the expense of x-y direction properties, such as sheet stiffness (measured as Stiffness Index). Thus, the invention provides a tissue product having improved z-direction properties, such as an improved resiliency, have relatively low stiffness, such as a Stiffness Index of about 12.0 or less. For example, in one preferred embodiment, the invention provides a single ply non-compressively dewatered tissue product having a basis weight from about 30 to about 40 gsm, a GMT greater than about 500 g/3″, and Stiffness Index less than about 10, such as from about 6.0 to about 10 and more preferably from about 6.0 to about 8.5 the tissue product comprising first and second fibrous outer layers and a middle fibrous layer disposed there-between the outer layers comprising from about 10 to about 30 percent, by weight of the layer, cross-linked hardwood fibers, and the middle layer is substantially free from cross-linked hardwood fibers.

In other embodiments the present disclosure provides a two-ply tissue product comprising a first through-air dried multi-layered tissue web and a second through-air dried multi-layered tissue web that are plied together using well-known techniques. The through-air dried multi-layered webs comprise at least a first and a second layer, wherein cross-linked fibers are selectively incorporated in only one of the layers and the other layer is substantially free of cross-linked fibers. The foregoing two-ply tissue product comprises from about 5 to about 30 percent, and more preferably from about 10 to about 25 percent, by weight of the product, cross-linked fiber, wherein the product has a basis weight from about 20 to about 50 gsm, a GMT from about 800 to about 1,200 g/3″, a sheet bulk greater than about 12.0 cc/g, such as from about 12.0 to about 16.0 cc/g, a TS7 from about 8.0 to about 12.0 and a TS750 less than about 60, such as from about 30 to about 60.

### Test Methods

### Sheet Bulk

Sheet Bulk is calculated as the quotient of the dry sheet caliper (μm) divided by the basis weight (gsm). Dry sheet caliper is the measurement of the thickness of a single tissue sheet measured in accordance with TAPPI test methods T402 and T411 om-89. The micrometer used for carrying out T411 om-89 is an Emveco 200-A Tissue Caliper Tester (Emveco, Inc., Newberg, Oreg.). The micrometer has a load of 2 kilo-Pascals, a pressure foot area of 2500 square millimeters, a pressure foot diameter of 56.42 millimeters, a dwell time of 3 seconds and a lowering rate of 0.8 millimeters per second.

### Tensile

Tensile testing was done in accordance with TAPPI test method T-576 “Tensile properties of towel and tissue products (using constant rate of elongation)” wherein the testing is conducted on a tensile testing machine maintaining a constant rate of elongation and the width of each specimen tested is 3 inches. More specifically, samples for dry tensile strength testing were prepared by cutting a 3 inches±0.05 inches (76.2 mm±1.3 mm) wide strip in either the machine direction (MD) or cross-machine direction (CD) orientation using a JDC Precision Sample Cutter (Thwing-Albert Instrument Company, Philadelphia, Pa., Model No. JDC 3-10, Serial No. 37333) or equivalent. The instrument used for measuring tensile strengths was an MTS Systems Sintech 11S, Serial No. 6233. The data acquisition software was an MTS TestWorks® for Windows Ver. 3.10 (MTS Systems Corp., Research Triangle Park, NC). The load cell was selected from either a 50 Newton or 100 Newton maximum, depending on the strength of the sample being tested, such that the majority of peak load values fall between 10 to 90 percent of the load cell's full scale value. The gauge length between jaws was 4±0.04 inches (101.6±1 mm) for facial tissue and towels and 2±0.02 inches (50.8±0.5 mm) for bath tissue. The crosshead speed was 10±0.4 inches/min (254±1 mm/min), and the break sensitivity was set at 65 percent. The sample was placed in the jaws of the instrument, centered both vertically and horizontally. The test was then started and ended when the specimen broke. The peak load was recorded as either the “MD tensile strength” or the “CD tensile strength” of the specimen depending on direction of the sample being tested. Ten representative specimens were tested for each product or sheet and the arithmetic average of all individual specimen tests was recorded as the appropriate MD or CD tensile strength the product or sheet in units of grams of force per 3 inches of sample. The geometric mean tensile (GMT) strength was calculated and is expressed as grams-force per 3 inches of sample width. Tensile energy absorbed (TEA) and slope are also calculated by the tensile tester. TEA is reported in units of gm cm/cm². Slope is recorded in units of kg. Both TEA and Slope are directionally dependent and thus MD and CD directions are measured independently. Geometric mean TEA and geometric mean slope are defined as the square root of the product of the representative MD and CD values for the given property.

### Tissue Softness Analyzer (TSA)

Sample softness was analyzed using an EMTEC Tissue Softness Analyzer (“TSA”) (Emtec Electronic GmbH, Leipzig, Germany). The TSA comprises a rotor with vertical blades which rotate on the test piece applying a defined contact pressure. Contact between the vertical blades and the test piece creates vibrations, which are sensed by a vibration sensor. The sensor then transmits a signal to a PC for processing and display. The signal is displayed as a frequency spectrum. The frequency analysis in the range of approximately 200 to 1000 Hz represents the surface properties of the test piece. A high amplitude peak correlates to a rougher surface. A further peak in the frequency range between 6 and 7 kHz represents the softness of the test piece. The peak in the frequency range between 6 and 7 kHz is herein referred to as the TS7 Softness Value and is expressed as dB V² rms. The lower the amplitude of the peak occurring between 6 and 7 kHz, the softer the test piece.

To measure TS750 a frequency analysis in the range of approximately 200 to 1000 Hz is performed with the amplitude of the peak occurring at 750 Hz being recorded as the TS750 value. The TS750 value represents the surface smoothness of the sample. A high amplitude peak correlates to a rougher surface. TS750 has units of dB V² rms. The TS750 value generally represents the structure of the sample which includes such things as any three-dimensional surface topography. Generally, samples having smooth surfaces with relatively low degrees of three-dimensional surface topography will produce a lower TS750 peak.

Test samples were prepared by cutting a circular sample having a diameter of 112.8 mm. All samples were allowed to equilibrate at TAPPI standard temperature and humidity conditions for at least 24-hours prior to completing the TSA testing. Only one ply of tissue is tested. Multi-ply samples are separated into individual plies for testing. The sample is placed in the TSA with the softer (dryer or Yankee) side of the sample facing upward. The sample is secured and the Softness Values measurements are started via the PC. The PC records, processes and stores all of the data according to standard TSA protocol. The reported TS7 and TS750 values is the average of five replicates, each one with a new sample.

### EXAMPLE

Single ply uncreped through-air dried (UCTAD) tissue webs were made generally in accordance with U.S. Pat. No. 5,607,551. The tissue webs and resulting tissue products were formed from various fiber furnishes including, eucalyptus hardwood kraft (EHWK), cross-linked EHWK (XL-EHWK) and Northern softwood kraft (NSWK).

Cross-linked fibers were prepared by first dispersing eucalyptus hardwood kraft (EHWK) in a pulper for approximately 30 minutes at a consistency of about 10 percent. The pulp was then pumped to a machine chest and diluted to a consistency of about 2 percent and then pumped to a headbox and further diluted to a consistency of about 1 percent. From the headbox, the fibers were deposited onto a felt using a Fourdrinier former. The fiber web was pressed and dried to form a fiber web having a consistency of about 90 percent and a bone dry basis weight from about 500 to 700 gsm. The fiber web was treated with a 25 percent solids solution of DMDHEU (commercially available from Omnova Solutions, Inc. under the trade name Permafresh®CSI-2) using a flooded-nip horizontal size press. In certain instances 0.01 percent by weight CMC (commercially available from CP Kelco under the trade name Finnfix®300 CMC) was added to the DMDHEU solution to adjust solution viscosity. The sheet was saturated in the flooded nip and squeezed to evenly distribute the cross-linker solution. After the size press, the sheet was dried (at approximately 220° F.) to around 92 percent consistency and rolled on a reel. The treated pulp was mechanically separated in a hammer mill using a screen with 3 mm holes. Separated fibers were pneumatically conveyed to an air-forming head where they were laid onto a carrier tissue at a basis weight of around 200 to 400 gsm. The airlaid fiber mat was continuously conveyed through a through-air dryer at about 170° F. The fiber mat was conveyed at a rate of around 1.8 to 2.5 m/min, for a total residence time from about 5 to about 7 minutes. The resulting cross-linked eucalyptus hardwood kraft fibers (XL-EWHK) were collected and used to prepare tissue webs as described below.

Northern softwood kraft (NSWK) furnish was prepared by dispersing NSWK pulp in a pulper for 30 minutes at about 2 percent consistency at about 100° F. The NSWK pulp was then transferred to a dump chest and subsequently diluted with water to approximately 0.2 percent consistency. Softwood fibers were then pumped to a machine chest. In certain instances, starch was added to the machine chest, as indicated in Table 2 below. Also, in certain instances, NSWK pulp was refined as set forth in Table 2 below.

Eucalyptus hardwood kraft (EHWK) furnish was prepared by dispersing EWHK pulp in a pulper for 30 minutes at about 2 percent consistency at about 100° F. The EHWK pulp was then transferred to a dump chest and diluted to about 0.2 percent consistency. The EHWK pulp was then pumped to a machine chest.

Cross-linked EHWK (XL-EWHK), prepared as described above, was dispersed in a pulper for 30 minutes at about 1 percent consistency at about 100° F. The XL-EWHK was then transferred to a dump chest and diluted to about 0.2 percent consistency. The XL-EWHK was then pumped to a machine chest.

TABLE 2

| | Refining | Starch | XL-EHWK | First Layer | Center Layer | Third Layer |
|---|---|---|---|---|---|---|
| Sample | (min) | (kg/MT) | (wt %) | (wt %) | (wt %) | (wt %) |
| Control 1 | — | — | — | EHWK (30%) | NSWK (40%) | EHWK (30%) |
| Control 2 | — | 2.5 | — | EHWK (30%) | NSWK (40%) | EHWK (30%) |
| Control 3 | — | 6.0 | — | EHWK (30%) | NSWK (40%) | EHWK (30%) |
| Control 4 | — | — | — | EHWK (30%) | NSWK (40%) | EHWK (30%) |
| Control 5 | — | 2.5 | — | EHWK (30%) | NSWK (40%) | EHWK (30%) |
| Inventive 1 | 2 | 2.5 | 12 | XL-EHWK (6%) | NSWK (40%) | XL-EHWK (6%) |
| | | | | EHWK (24%) | | EHWK (24%) |
| Inventive 2 | 2 | 6 | 12 | XL-EHWK (6%) | NSWK (40%) | XL-EHWK (6%) |
| | | | | EHWK (24%) | | EHWK (24%) |
| Inventive 3 | 1 | 2.5 | 24 | XL-EHWK (12%) | NSWK (40%) | XL-EHWK (12%) |
| | | | | EHWK (18%) | | EHWK (18%) |
| Inventive 4 | 1 | 6 | 24 | XL-EHWK (12%) | NSWK (40%) | XL-EHWK (12%) |
| | | | | EHWK (18%) | | EHWK (18%) |

The stock solutions were pumped to a 3-layer headbox to form a three layered tissue web. NSWK fibers were disposed in the middle layer and EHWK or XL-EHWK and EHWK were disposed in the two outer layers. The relative weight percentage of the layers was 30%/40%/30%, based upon the total weight of the web. The target basis weight for all samples was about 36 gsm (as-is basis weight). The formed web was non-compressively dewatered and rush transferred to a transfer fabric traveling at a speed about 24 percent slower than the forming fabric. The transfer vacuum at the transfer to the TAD fabric was maintained at approximately 6 inches of mercury vacuum to control molding to a constant level. The web was then transferred to a throughdrying fabric, dried and wound into a parent roll. The parent rolls were then converted into 1-ply bath tissue rolls. Calendering was done with a steel-on-rubber setup. The rubber roll used in the converting process had a hardness of 40 P&J and a load of 60 PLI. The rolls were converted to a diameter of about 117 mm. Samples were conditioned and tested, the results of which are summarized in Table 3 below. The finished tissue product properties are summarized in Table 3 below.

TABLE 3

| | Basis Weight | GMT | | | GMM | Stiffness |
|---|---|---|---|---|---|---|
| Sample | (gsm) | (g/3″) | TS7 | TS750 | (g) | Index |
| Control 1 | 35.5 | 769 | 11.5 | 54.3 | 5812 | 7.6 |
| Control 2 | 36.4 | 1030 | 13.7 | 65.9 | 6693 | 6.5 |
| Control 3 | 36.0 | 1200 | 13.8 | 68.9 | 7289 | 6.1 |
| Control 4 | 35.0 | 520 | 10.5 | 42.1 | 5184 | 10.0 |
| Control 5 | 34.8 | 720 | 12.3 | 59.9 | 5940 | 8.3 |
| Inventive 1 | 35.8 | 1033 | 11.0 | 48.2 | 7657 | 7.4 |
| Inventive 2 | 35.3 | 1231 | 12.5 | 61.1 | 8343 | 6.8 |
| Inventive 3 | 34.8 | 584 | 9.5 | 34.1 | 5945 | 10.2 |
| Inventive 4 | 34.5 | 681 | 9.2 | 39.2 | 6488 | 9.5 |

While tissue webs, and tissue products comprising the same, have been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto and the foregoing embodiments:

In a first embodiment the present invention provides a tissue product comprising a fibrous structure comprising first and second fibrous layers the first layer comprising from about 5 to about 30 percent, by weight of the layer, cross-linked cellulosic fibers, and the second layer substantially free from cross-linked cellulosic fibers, the fibrous structure having a TS7 value less than about 12 and a TS750 value less than about 60.

In a second embodiment the present invention provides the non-compressively dewatered tissue product of the first embodiment having a sheet bulk greater than about 12.0 cc/g.

In a third embodiment the present invention provides the non-compressively dewatered tissue product of the first or the second embodiments having a geometric mean tensile strength (GMT) from about 500 to about 1,250 g/3″.

In a fourth embodiment the present invention provides the non-compressively dewatered tissue product of any one of the first through the third embodiments wherein the product has a GMT from about 500 to about 1,250 g/3″ and a Stiffness Index less than about 12.

In a fifth embodiment the present invention provides the non-compressively dewatered tissue product of any one of the first through the fourth embodiments wherein the product has a basis weight from about 20 to about 50 grams per square meter (gsm).

In a sixth embodiment the present invention provides the non-compressively dewatered tissue product of any one of the first through the fifth embodiments wherein the tissue web comprises from about 10 to about 25 percent, by weight of the product, cross-linked cellulosic fibers.

In a seventh embodiment the present invention provides the non-compressively dewatered tissue product of any one of the first through the sixth embodiments wherein the cross-linked cellulosic fiber comprises eucalyptus hardwood kraft fibers reacted with a cross-linking reagent selected from the group consisting of 1,3-dimethyl-4,5-dihydroxy-2-imidazolidinone (DMDHU), 1,3-dihydroxymethyl-4,5-dihydroxy-2-imidazolidinone (DMDHEU), bis[N-hydroxymethyl]urea (DMU), 4,5-dihydroxy-2-imidazolidinone (DHEU), 1,3-dihydroxymethyl-2-imidazolidinone(DMEU) and 4,5-dihydroxy-1,3-dimethyl-2-imidazolidinone (DMeDHEU).

In an eighth embodiment the present invention provides the non-compressively dewatered tissue product of any one of the first through the seventh embodiments further comprising a third fibrous layer disposed immediately adjacent to the second fibrous layer, the third fibrous layer comprising cross-linked cellulosic fiber.

In a ninth embodiment the present invention provides a method of forming a soft and smooth tissue product comprising the steps of: (a) dispersing a cross-linked hardwood pulp fiber in water to form a first fiber slurry; (b) dispersing uncross-linked conventional wood pulp fibers in water to form a second fiber slurry; (c) depositing the first and second fiber slurries in a layered arrangement on a moving belt to form a tissue web having first and second outer layers and a middle layer wherein the first fiber slurry forms the first and second outer layers and the second fiber slurry forms the middle layer; (d) non-compressively drying the tissue web to a yield a dried tissue web having a consistency from about 80 to about 99 percent solids; and (e) calendering the dried tissue web to yield tissue product having a TS7 from about 6.0 to 12 and a TS750 from about 30 to about 60 and a GMT from about 500 to about 1,250 g/3″.

In a tenth embodiment the present invention provides the method of the ninth embodiment wherein the resulting tissue product has a basis weight from about 20 to about 50 gsm and a sheet bulk of about 12 cc/g.

In an eleventh embodiment the present invention provides the method of the ninth or tenth embodiments wherein the cross-linked hardwood pulp fiber comprises eucalyptus hardwood kraft pulp fibers reacted with a cross-linking agent selected from the group consisting of DMDHU, DMDHEU, DMU, DHEU, DMEU, and DMeDHEU.

In a twelfth embodiment the present invention provides the method of any one of the ninth through eleventh embodiments wherein the tissue product comprises from about 5 to about 30 percent cross-linked hardwood pulp fiber and from about 10 to about 50 percent uncross-linked Northern softwood kraft fibers.

In a thirteenth embodiment the present invention provides the method of any one of the ninth through twelfth embodiments wherein the step of calendering comprises passing the web through a nip having a load of at least about 50 pli, wherein the step of calendering reduces the sheet bulk from about 30 to about 50 percent.

In a fourteenth embodiment the present invention provides the method of any one of the ninth through thirteenth embodiments wherein the dried tissue web has a sheet bulk greater than about 15 cc/g and the resilient high bulk tissue product has a sheet bulk greater than about 12 cc/g.

1. A non-compressively dewatered fibrous structure comprising first and second fibrous layers and a third fibrous layer disposed there-between, wherein the first and second fibrous layers comprise cross-linked cellulosic fibers, and the third fibrous layer is substantially free from cross-linked cellulosic fibers, the fibrous structure comprising from about 5 to about 30 percent, by weight of the structure, cross-linked cellulosic fibers and having a geometric mean tensile (GMT) strength from about 500 to about 1,250 g/3″, a TS7 from about 6.0 to about 12.0 and a TS750 from about 30 to about 60.

2. The fibrous structure of claim 1 having a GMT from about 600 to about 1,000 g/3″ and a Stiffness Index less than about 12.

3. The fibrous structure of claim 1 having a sheet bulk from about 12.0 to about 16.0 cc/g.

4. (canceled)

5. The fibrous structure of claim 1 wherein the cross-linked cellulosic fibers comprise hardwood kraft fibers reacted with a cross-linking reagent selected from the group consisting of 1,3-dimethyl-4,5-dihydroxy-2-imidazolidinone (DMDHU), 1,3-dihydroxymethyl-4,5-dihydroxy-2-imidazolidinone (DMDHEU), bis[N-hydroxymethyl]urea (DMU), 4,5-dihydroxy-2-imidazolidinone (DHEU), 1,3-dihydroxymethyl-2-imidazolidinone (DMEU) and 4,5-dihydroxy-1,3-dimethyl-2-imidazolidinone (DMeDHEU).

6. A tissue product comprising at least one multi-layered through-air dried tissue web having first and second fibrous layers and a third fibrous layer disposed there-between, wherein the first and second fibrous layers comprise cross-linked cellulosic fibers, and the third fibrous layer is substantially free from cross-linked cellulosic fibers, the product having a TS7 equal to or less than 0.0049*GMT+6.2734 and a TS750 equal to or less than 0.0049*GMT+6.2734, where GMT is the geometric mean tensile strength of the product expressed in g/3″, and the product GMT ranges from about 500 to about 1,250 g/3″.

7. The tissue product of claim 6 having a basis weight from about 20 to about 50 gsm.

8. The tissue product of claim 6 having a GMT from about 600 to about 1,000 g/3″ and a Stiffness Index from about 6.0 to about 10.0.

9. The tissue product of claim 6 having a sheet bulk from about 12.0 to about 16.0 cc/g.

10. The tissue product of claim 6 comprising from about 5 to about 30 percent, by weight of the product, cross-linked cellulosic fibers.

11. The tissue product of claim 6 wherein the cross-linked cellulosic fibers comprise eucalyptus hardwood kraft fibers reacted with a cross-linking reagent selected from the group consisting of 1,3-dimethyl-4,5-dihydroxy-2-imidazolidinone (DMDHU), 1,3-dihydroxymethyl-4,5-dihydroxy-2-imidazolidinone (DMDHEU), bis[N-hydroxymethyl]urea (DMU), 4,5-dihydroxy-2-imidazolidinone (DHEU), 1,3-dihydroxymethyl-2-imidazolidinone(DMEU) and 4,5-dihydroxy-1,3-dimethyl-2-imidazolidinone (DMeDHEU).

12. (canceled)

13. (canceled)

14. (canceled)

15. (canceled)

16. (canceled)

17. (canceled)

18. (canceled)

19. (canceled)

20. A method of forming a tissue product comprising the steps of:
a. dispersing a cross-linked hardwood pulp fiber in water to form a first fiber slurry;
b. dispersing uncross-linked conventional wood pulp fibers in water to form a second fiber slurry;
c. depositing the first and second fiber slurries in a layered arrangement on a moving belt to form a tissue web having first and second outer layers and a middle layer wherein the first fiber slurry forms the first and second outer layers and the second fiber slurry forms the middle layer;
d. non-compressively drying the tissue web to a yield a dried tissue web having a consistency from about 80 to about 99 percent solids; and
e. calendering the dried tissue web to yield tissue product having a TS7 from about 6.0 to 12, a TS750 from about 30 to about 60 and a geometric mean tensile (GMT) from about 500 to about 1,250 g/3″.

21. The method of claim 20 wherein the cross-linked hardwood pulp fiber comprises eucalyptus hardwood kraft pulp fibers reacted with a cross-linking agent selected from the group consisting of DMDHU, DMDHEU, DMU, DHEU, DMEU, and DMeDHEU.

22. The method of claim 20 wherein the tissue product comprises from about 5 to about 30 percent cross-linked hardwood pulp fiber.

23. The method of claim 20 wherein the step of calendering comprises passing the web through a nip having a load of at least about 50 pli, wherein the step of calendering reduces the sheet bulk from about 30 to about 50 percent.
